(19) United States
(12) Patent Application Publication
(10) Pub. No.: US 2010/0088934 A1
(43) Pub. Date: Apr. 15, 2010

(54) Fuel Door Display Cover

(76) Inventor: Jesse Mungia, Gredna, LA (US)

Correspondence Address: EZRA L. SCHACHT, 1620 WEST MAIN STREET, HOUSTON, TX, 77006-4712, US

(21) Appl. No.: 12/636,754

(22) Filed: Dec. 13, 2009

Related U.S. Application Data
(63) Continuation-in-part of application No. 09/790,995, filed on Feb. 22, 2001, now abandoned.

(51) Int. Cl. G09F 21/04

(52) U.S. Cl. 40/591

(57) ABSTRACT

A display cover for a vehicle fuel door with a broad area for the placement of a printed logo or message. The display cover conformably surrounds the fuel door with a contractile elastic belt to draw the cover tightly about the fuel door. The outward exposed surface of the cover visually displays a message or logo in a trendy location. The cover is designed to display the message in a novel location and still be easily removed without marring the vehicle finish unlike a traditional bumper sticker.

### CROSS-REFERENCE TO RELATED APPLICATIONS:

This is a continuation-in-part (CIP) of application Ser. 09/790,995, filed Feb. 22, 2001 now abandoned.

### FIELD OF THE INVENTION

This application relates to fuel door display covers for automotive vehicles. Specifically, this application relates to ornamental display covers for automotive vehicle fuel doors.

### BACKGROUND OF THE RELATED ART

Original motorized vehicles using liquid fuel had exposed fuel tanks with upwardly turned fill tubes having a cap. As automotive engineers designed more aerodynamic and aesthetically pleasing vehicle exterior designs, fuel tanks were hidden from view by smooth exterior fenders, quarter panels and other body parts, but the fill tube of the gas tank extended through perforations in the exterior fender, quarter panels or other body parts. As automobiles continued to evolve, the end of the fill tube was recessed to terminate within the exterior surface of the vehicle exterior, and was accessed by opening small doors hinged to swing out of the closed position to expose the fill tube.

Fuel doors are commonly coated with the same paint and coating system used to coat the surrounding body part on the exterior surface of the vehicle so as to provide a smooth, continuous and unnoticeable access door at a convenient height and location for driver refueling. Increasingly, fuel doors are secured in the closed position during normal vehicle operation, and opened only when mechanically released by a switch or lever located inside the vehicle, usually near the driver's left side. Fuel doors are used upon each refueling of the vehicle, resulting in oil and dirt deposits on the fuel door and wear on the paint and finish from repeated contact by human hands. Also, fuel is often inadvertently spilled or sprayed on the fuel door, on the hands that later touch the fuel door, and is harmful to the paint and finish of the vehicle.

Many people choose to display messages, symbols, designs, logos and other forms of communication on their vehicles. These messages may be of a business or commercial nature such as the logo or symbol of the vehicle manufacturer or commercial owner of a fleet vehicle, or of a personal nature such as the logo of a favorite sports team. The most prevalent manner of displaying such messages are bumper stickers.

There are several problems with using stickers on a vehicle exterior. Stickers are usually usable only once. Where more than one driver uses the vehicle, stickers cannot easily be removed by the driver that does not want to drive a vehicle bearing the sticker. Also, the sticker is generally permanent until removed; that is, it cannot be used seasonally or on special occasions when the message may be more appropriate. Stickers are also difficult to remove, especially after being on the vehicle for a prolonged time. When stickers are removed from a vehicle exterior, they often leave an unsightly, sticky residue on the exterior finish of the vehicle, and the paint underneath the location of the sticker will generally be noticeably less faded than the surrounding paint. Sometimes the paint itself is removed with the sticker.

Many drivers display messages on banners or flags hanging from the antennae or other part of the vehicle, but antennae banners cause driver distraction, noise and undesirable antennae movement at high speeds or in high winds. Many drivers use outwardly facing signs or displays usually placed on the inside surface of the vehicle glass, often using suction cups for securing the display to the glass. These displays obstruct precious view and glass area within the vehicle, and may block the driver's view. Reversed stickers may be applied to the inside surface of the glass and readable from the outside, but these have the same problems as exterior stickers.

The problems with the existing methods and apparatus for displaying messages deter many from expressing themselves with a display on their vehicle, or from allowing others that may use their vehicle from displaying their messages. Seasonal or event-specific displays or messages are not usually made on vehicles because of the visible long-term effects on the appearance of the vehicle. What is needed is a way of allowing a driver to express or display a message that is temporary, that is, easily applied, removed and cleaned, and one that is not harmful to the exterior finish of the vehicle. This solution would even allow a non-owner driver to express seasonal or event-related messages while using the vehicle, and would leave no noticeable residue or scratches on the exterior finish of the vehicle.

“Message” as used herein means message, logo, display, symbol, letter, number, expression, emblem, trademark, sign, picture, appliqué, or other non-moving communication through visual means. “Material” as used herein means cloth, plastic sheet, or other suitable flexible substrate that can be printed upon.

In prior art, McKee, John P., U.S. Pat. No. 4,867,216 (McKee '216), a vehicle cover is disclosed having a plurality of raised portions projecting outwardly from surface of a flexible material. These raised portions space the vehicle cover from the surface of the vehicle to minimize surface contact and ease the removal of the cover in wet freezing conditions. The present application eliminates these raised portions to allow a detailed message to be applied on smooth printable material using known printing techniques, such as block printing, silk screening, etc. Applicant requires that no raised portions be allowed on a fuel door cover to inhibit printing. Applicant understands “raised portions” to be the same as bumps or projections spaced over the surface of the material to act like little tent posts to prevent the bulk of the cloth from touching and freezing to the surface of the automobile. The projections are high enough and closely spaced enough to interfere with any printing process.

In McKee, the “substantially smooth” material has necessary raised portions to space the material away from the surface of the automobile. McKee shows these raised portions in his drawings to be substantial and 3/16 of an inch high and at a maximum spacing of ¾ of an inch in distance from each other. These raised portions cannot be printed over without disrupting the printed image.

A series of printing test were performed by applicant. Physical samples were tested by applicant to show that raised portions of the size and spacing specified by McKee in his specification will disrupt printed messages, leaving gaps and distortions in the printed message.

In McKee, the material, as broadly cited in his patent, contains closely spaced raised portions that interfere with a printed image. These raised portions are a necessary element of his claims to prevent his material from freezing to the vehicle surface.

Applicant claims printable smooth material having no such raised portions, since raised portions versus no raised portions are mutually exclusive conditions. Applicant claims a “printable smooth” material in distinction from the material specified and claimed by McKee.

In McKee, the indistinct use of the words “substantially smooth” in his claims does not counter the fact that his material as broadly cited in his specification is not smooth enough for printing. Since McKee '216 does not directly show a printable smooth surface, he cannot claim his material is suitable for the acceptable display of a message. Furthermore, McKee claims an extensive bumpy cover over a substantial portion of an automobile's surface. Applicant teaches a smooth, printable cover over a much smaller region of the car. Applicant does not need to cover more than the fuel door to display is message, whereas, McKee needs to cover most of the exterior of a car to protect from freezing rain and snow.

In prior art, Blake, U.S. Pat. No. 6,176,596, glues a non-removable sticker in a more traditional area of a vehicle, the rear bumper area or on a trailer hitch cover door located at the rear bumper area of a vehicle, not at the novel, strategic place over the fuel door located on the side of the vehicle.

### SUMMARY OF THE INVENTION

The fuel door cover of the present application provides a method and an apparatus for displaying messages at a highly visible location on the vehicle without using stickers or obstructing any view through vehicle glass. The fuel door cover of the present application provides for easy installation and removal, it may be washable and may be made to allow interchangeable displays.

The fuel door of a vehicle offers a strategically favorable place for temporarily or permanently displaying a message. The fuel door is usually in a position that is easily noticeable to the observer. The present application provides a method and apparatus for displaying a message on a vehicle without using stickers.

In prior art, Blake, U.S. Pat. No. 6,176,596, glues a non-removable sticker in a more traditional area of a vehicle, the rear bumper area or on a trailer hitch cover door located at the rear bumper area of a vehicle, not at the novel, strategic place over the fuel door located on the side of the vehicle.

It is desirable that the fuel door cover is easily removable and washable, and that it have a surface suitable for display of a message. It is also desirable that the fuel door cover be fitted to lay flat across the exterior flat portion of the fuel door, and that it is secured to the fuel door in a manner that does not interfere with either the hinge(s) or with latching or locking mechanisms common on many vehicles.

Applicant places his invention solely over the gas cap door with no permanent adhesion to mar the finish. Blake '596 teaches away from the gas cap. He teaches a space for a sticker on his trailer-hitch cover located at the lower rear of his vehicle, not at the strategically located gas cap door. Applicant is hoping to start a novel trend of placing slogans, emblems, or logos on a removable, gas cap door cover and wishes to protect this novel idea. The “place where” is most important to this trend. Neither McKee nor Blake, alone or together, teaches the necessarily smooth, printable, removable cover located on the vehicle fuel door.

So that the features and advantages of the present application can be understood in detail, a more particular description of the application, briefly summarized above, may be had by reference to the embodiments thereof that are illustrated in the appended drawings. It is to be noted, however, that the appended drawings illustrate only typical embodiments of this application and are therefore not to be considered limiting of its scope, for the application may admit to other equally effective embodiments.

### BRIEF DESCRIPTION OF THE DRAWINGS

FIG. 1 shows an embodiment of the fuel door cover installed on the fuel door of a typical vehicle.

FIG. 2 shows an enlarged, frontal view of the fuel door cover of the present application installed on the fuel door of a typical vehicle.

FIG. 3 shows an enlarged, rear view of the fuel door cover.

FIGS. 4a and 4b show a printed message with and without interfering raised portions incorporated in the fuel door cover material.

FIG. 5 shows an enlarged, rear (inside) fuel door cover of the present application secured to a fuel door using a channel sewn into the fabric and a draw string or elastic band therein.

FIG. 6 (prior art) shows a cross-sectioned view of the raised portions taught in McKee '216.

FIG. 7 (prior art) shows a perspective view of the raised portions taught in McKee '216.

and

FIG. 8 (prior art) shows a perspective view of a car cover.

### DETAILED DESCRIPTION OF THE INVENTION

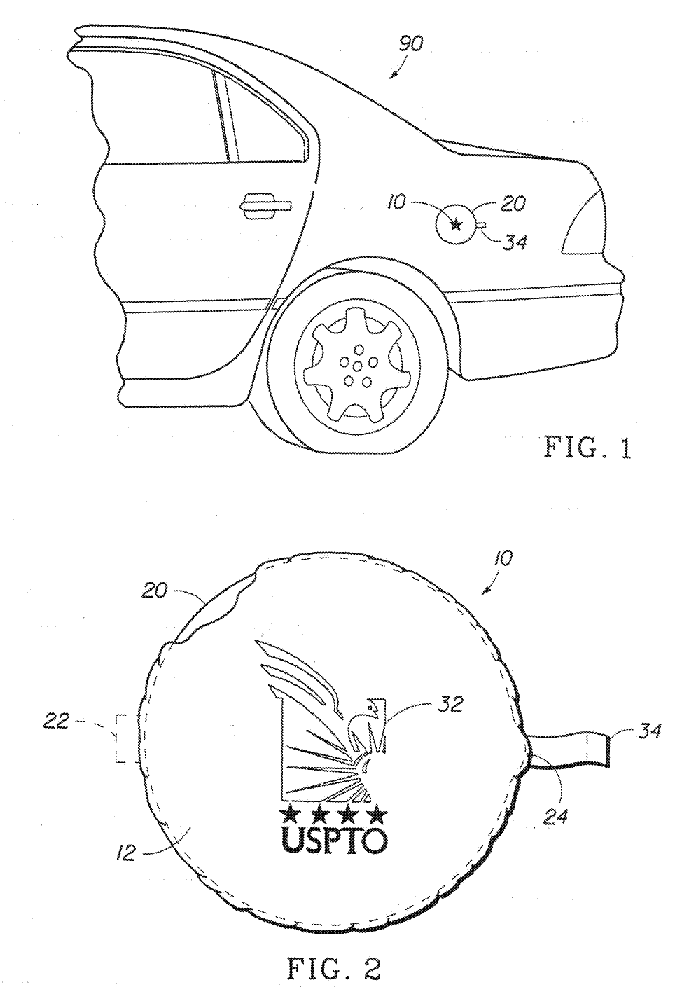

FIG. 1 shows the fuel door cover of the present application installed onto the fuel door of a typical automobile 90. The fuel door cover 10 in FIG. 1 and FIG. 2 is made of printable fabric or other materials. The fuel door 20 is located on the rear fender. Material 12 can be stretched or drawn to provide a flat display portion in the center thereof. There are many methods of applying a message 32 to fabric that are known in the art and embodied in T-shirts, banners, flags, ribbons and the like. Fabric may be selected for its particular compatibility with the application of messages to the display portion, or fabric can be manufactured to bear a selected message without post-manufacture application of the message. Fabric can also be pre-washed or treated with chemicals to make it water-resistant, luminescent, wrinkle resistant, fade resistant or shrink-resistant, and these fabric treatments are well known in the art. The display may be applied to the fuel door cover using an appliqué. As a result of all of these advantages, fabric is the preferred material for making the fuel door cover of the present application. The material can be printed by commercial means after the assembly of the fuel door cover. Optional tab 34 assists in opening the fuel door.

In FIG. 2, the fuel door cover 10 of the present application is comprised of a pliable material 12 in sheet form having a message 32 printed generally in the center. Some fuel doors are round, some are oval and some are of a rounded-rectangular shape, and the sheet of pliable material 12 is cut to accommodate the size and shape of the fuel door to be covered. In a preferred embodiment, the sheet of pliable material 12 should be cut to provide a rounded sheet approximately 9.5 inches in diameter thereby providing a display portion approximately 7 inches in diameter in the center thereof. This display portion is to be disposed on the exterior side of the fuel door cover with the message visible to the observer when the fuel door is in its closed position shown in FIGS. 1 and 2.

FIG. 2 shows an enlarged view of the fuel door cover 10, the vehicle fuel door 20, optional tab 34, hidden fuel door hinge 22, message 32 and fuel door finger notch 24. In the embodiment of the present application shown in FIG. 2, the message is placed directly on the material 12 comprising the fuel door cover 10. The message may be applied to the material 12 according to the chemical and physical compatibility of the material comprising the message and the material 12, and includes printing, hot pressing, silk screening, embroidering, stitching, marking, writing, stamping, dyeing, adhering, staining, treating and other methods of imposing a visible message on the display portion of the fuel door cover 10. Also included within the scope of the present application is the addition of chemicals or agents to the message or the display portion of the material 12 for luminescence during darkness and photo-reactive chemicals. Material 12 is understood to be a single or multiple layer of material. Each of a multiple layer sheet of material 12 must not have any raised portions or coarse texture that would interfere with the printing processes used to apply the message 32. As an example, a cover having a single layer of weather and fade resistant cloth with a silk screened image or message in one or several colors would suffice.

The fuel door cover of the present application allows the use to display any message including, but not limited to logos and trademarks related to sports or music, seasonal and holiday symbols, political statements, humorous displays and the like, may be displayed on the display portion disposed on the exterior side of the fuel door cover 10.

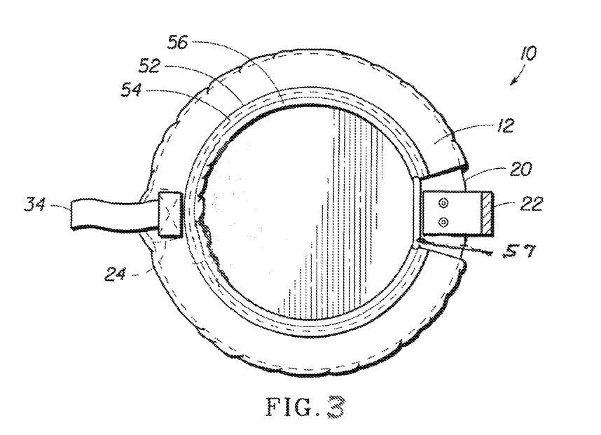

In FIG. 3, the preferred embodiments of the application uses a contractile elastic band 57. The elastic band is confined within channels 56 to draw the fuel door cover pliable material 12 tightly about fuel door 20. The contractile elastic band can be attached by glue, sewing or heat fusing to the perimeter of the fuel door cover. As the elastic band contracts, it hold the material taught over the outer surface of the fuel door and displays a message without distortion. The elastic band will retain the fuel door cover while the vehicle is in motion without fear of loss. The contractile elastic band may be of a round or rectangular or other suitably shaped cross section to facilitate adherence to the perimeter of the material 12. Alternately, the fuel door cover 10 of the present application can be secured to the fuel door 20 using a variety of securing means including clips, buckles, zippers, straps, strings or straps, hook-and-loop fasteners (Velcro™), drawstrings or other securing means. The material is conformably wrapped and held taught over the edges of the fuel door and secured thereto. The outer surface of the material remains flat to display a message. Alternately, the cover can be secured by at least one set of straps attached to the perimeter of said material. These straps can have hook-and-loop type fasteners to conformably secure the fuel door cover.

In FIG. 5, a draw string 54 is tightened and secured in a knot or bow to hold material 12 tightly around the edge of the fuel door 20. Two channels 56 formed by removing portions of the edge 52 of the material 12 adjacent to the hinge 22 and the pull tab 34, folding the remaining original edge 52 of the material 12 over onto itself, and then sewing or stitching the edge 52 of the material 12 to form two opposing channels 56. A draw string 54 having a first end 62 and a second end 64 is threaded through the channels 56, pulled taught and tied one to the other. The material 12 is thereby sufficiently taught to secure the fuel door cover 10 to the fuel door 20 during high vehicle speeds and winds, yet allows easy removal of the fuel door cover 10 from the fuel door 20 by stretching the elastic ring member and slipping the edge 52 of the material 12 over the outer edge of the fuel door 20 and remove the fuel door cover from the fuel door.

The material 12 comprising the fuel door cover 10 can be treated with chemicals or agents to impart high visibility, appearance and moisture resistance to prevent icing and wetness of the cover and to improve handling of the fuel door. The material 12 can also be chemically treated or otherwise manufactured in a way that promotes the adherence of any messages applied to the display portion of the fuel door cover.

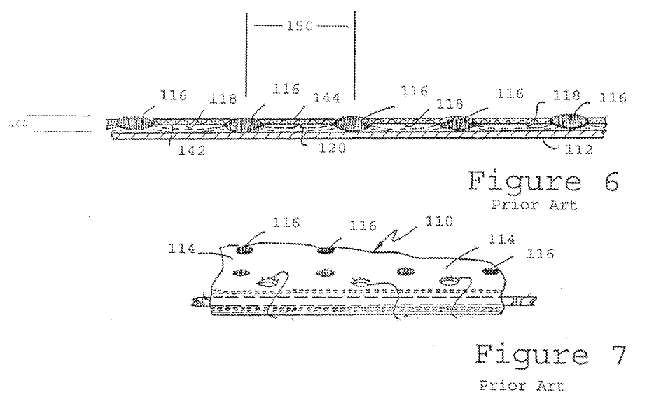

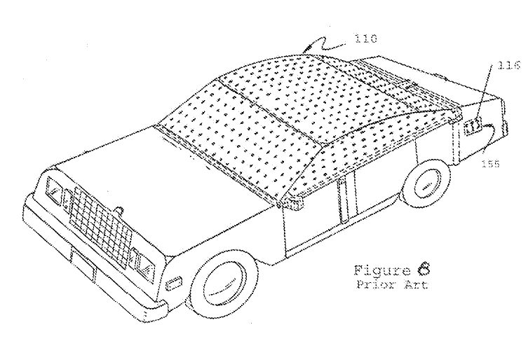

In order to call attention to the physical and functional distinctions between the current application and the prior art, reference is made to FIGS. 6 and 7 showing a prior art cross-section of the McKee car cover. The body of the car 112 is covered with material 142 having raised portions 116, extending both above and below the cover fabric 118. These raised portions 116 function to hold the lower surface 120 of the fabric away from the car surface 112. The distance 150 between each projection is taught to be ½ to ¾ inches in order that the material remains tented between raised portions and does not sag and touch the car surface and freezing to the car. These raised portions 116 are taught as being 3/16 inch thickness below the surface 118 of the material to prevent the cover from contacting between car surface 112 and the underside of the flexible material fabric 118. FIG. 7 shows a prior art representation of the same material in perspective. The upper surface 114 of the car cover is closely covered with raised portions 116 projecting above and below the material 114 to elevate the bulk of the cover from close contact with the car surface to prevent adhesion during freezing conditions. FIG. 8 is a prior art, perspective view of a car with cover 110, a portion of which is placed over an integral element 155 and is shown with raised portions 116.

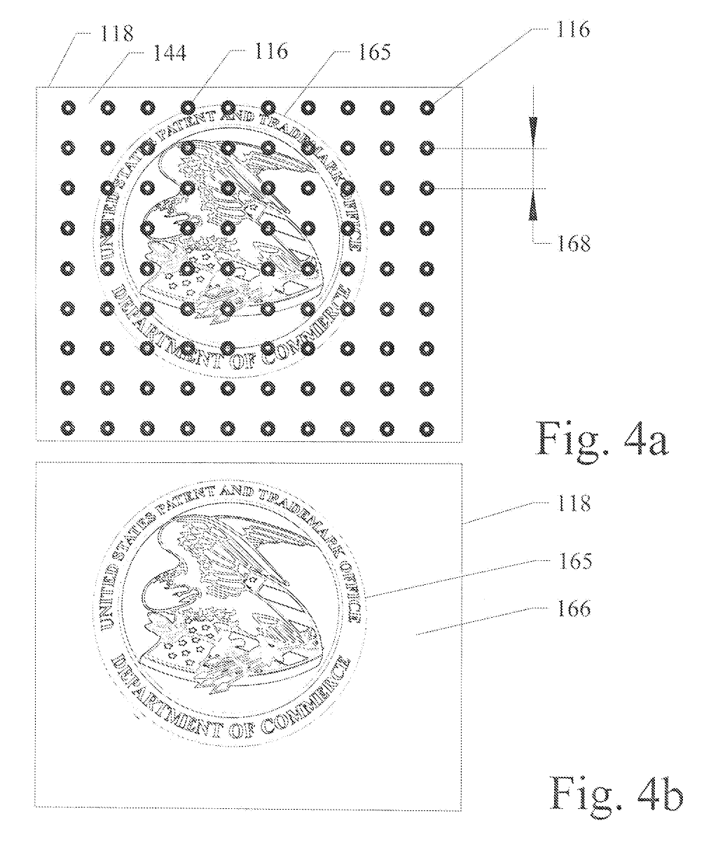

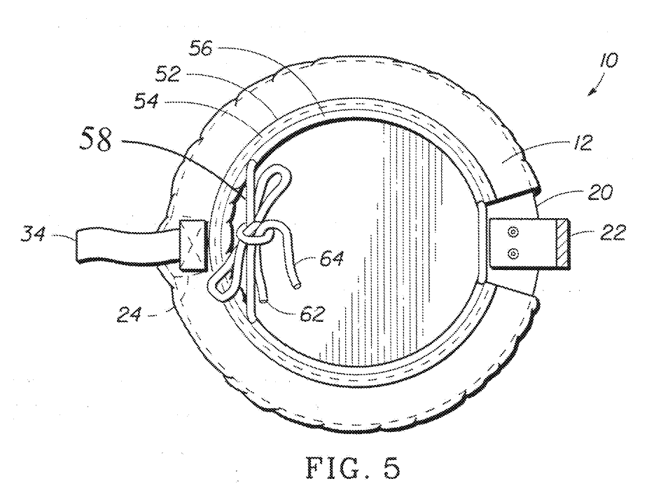

These raised portions prevent the clear printing or application of a logo or indicia, in that the car cover material is not flat and printable. This is best illustrated in FIGS. 4a, a prior art representation of a fuel door cover 118 with raised portions 116 spaced a distance apart 168 on material 118 as taught by McKee. The regions 144 between the raised portions 116 are held free of the surface of the vehicle to prevent adhesion by freezing moisture. The minimum number of raised portions taught by McKee would be 48 in number on a 6 by 6 inch door cover. This multiplicity of raised portions certainly interferes with commercial printing processes described elsewhere and would cause severe distortion or missing spots in any printed message 165. FIG. 4b, lacking the raised portions, teaches a vehicle fuel door cover comprised of smooth and printable material 118 having a printable surface 166 to faithfully render a message 165 in a clear and desirable manner.

FIG. 8 is a prior art perspective drawing of a vehicle cover 110 having multiple raised portions 116 on integral element 155.

While the foregoing is directed to the preferred embodiment of the present application, other and further embodiments of the application may be devised without departing from the basic scope thereof, and the scope thereof is determined by the claims which follow.

What is claimed is:

1. An apparatus for covering a vehicle fuel door comprising a pliable, smooth and printable material; the material conformably wrapped and held taught over the edges of the fuel door and secured thereto by securing means; said material displaying a message.

2. An apparatus as cited in claim 1 comprising a contractile elastic band attached to the perimeter of said material to conformably secure said material over said fuel door.

3. An apparatus as cited in claim 1 comprising a drawstring sewn within at least one channel on the perimeter of said material; the drawstring upon tightening and knotting, conformably securing said material over said fuel door.

4. An apparatus as cited in claim 1 comprising at least one set of straps attached to the perimeter of said material; the at least one set of straps having hook-and-loop type fasteners to conformably secure said fuel door cover.
